(19) United States
(12) Patent Application Publication
(10) Pub. No.: US 2026/0251787 A1
(43) Pub. Date: Aug. 27, 2026

(54) ULTRASONIC IMAGING PROBE

(71) Applicant: VERMON, TOURS (FR)

(72) Inventors: Benjamin GUERIF, TOURS (FR); Martin FLESCH, TOURS (FR)

(21) Appl. No.: 19/161,598

(22) PCT Filed: Feb. 22, 2024
(86) PCT No.: PCT/EP2024/054556

§ 371 Date: Sep. 2, 2025

(30) Foreign Application Priority Data
Mar. 3, 2023 (FR) FR2302002

(51) Int. Cl. G01S 15/89

(52) U.S. Cl. CPC G01S 15/8925

(57) ABSTRACT

The present description concerns an ultrasonic imaging probe (100) comprising a plurality of elementary ultrasonic transducers (111) arranged in an array of rows and columns, in which the elementary transducers (111) are distributed into a plurality of elementary groups (113), each comprising a plurality of transducers (111), the probe comprising, for each elementary group (113), an analog micro-beamforming circuit (123) individually coupled to each transducer (111) in the group (113) and adapted to delivering an analog signal generated by delay and summing of analog response signals of the elementary transducers (111) in the group (113), wherein each elementary group (113) is formed of an assembly of adjacent elementary transducers (111), said assembly having at least one dimension, in the row direction, different from a dimension, in the column direction.

The present application is based on and claims priority of French patent application FR 2302002 filed on Mar. 3, 2023, entitled “Ultrasonic imaging probe,” which is incorporated herein by reference within the limits provided by law.

### TECHNICAL FIELD

The present disclosure concerns the field of ultrasonic imaging, and more particularly aims at an ultrasonic imaging probe intended to be connected to an external control and processing system via a cable, the probe incorporating a plurality of ultrasonic transducers and electronic circuits for controlling these transducers.

### Prior Art

Various architectures of ultrasonic imaging probes have already been provided.

It would be desirable to at least partly improve certain aspects of known ultrasonic imaging probes.

The forming of an ultrasonic imaging probe comprising analog circuits adapted to implement micro-beamforming functions, for example for the implementation of ultra-fast acquisition scenarios, is here more particularly considered.

### SUMMARY OF THE INVENTION

An embodiment provides an ultrasonic imaging probe comprising a plurality of elementary ultrasonic transducers arranged in an array of rows and columns, the probe comprising, for each elementary ultrasonic transducer, a specific receive circuit connected to an electrode of the transducer and adapted to amplifying an electrical response signal generated by the elementary transducer during a phase of reception of an ultrasonic wave, wherein the elementary transducers are distributed into a plurality of elementary groups, each comprising a plurality of transducers, the probe comprising, for each elementary group, an analog micro-beamforming circuit individually coupled to an output terminal of the receive circuit of each transducer in the group, and adapted to delivering an analog signal generated by delay and summing of analog output signals of the receive circuits of the elementary transducers in the group, in which each elementary group is formed of an assembly of adjacent elementary transducers, said assembly having at least one dimension, in the row direction, different from a dimension, in the column direction, or wherein the elementary transducers each have an elongated shape in the row or column direction, and each elementary group is formed of an assembly of adjacent elementary transducers, said assembly having a square general shape.

According to an embodiment, each elementary group comprises a number of elementary transducers different from a squared integer.

According to an embodiment, the elementary groups have interlocking shapes.

According to an embodiment, the elementary groups have interlocking head-to-tail L shapes, or interlocking head-to-tail F-shaped shapes.

According to an embodiment, the elementary groups have interlocking cross shapes.

According to an embodiment, each elementary group is only formed of adjacent elementary transducers of a same row or of a same column of the array of elementary transducers.

According to an embodiment, each column of elementary transducers of the array of elementary transducers comprises a plurality of elementary groups, each comprising a plurality of adjacent elementary transducers of the column, and/or each row of elementary transducers of the array of elementary transducers comprises a plurality of elementary groups, each comprising a plurality of adjacent elementary transducers of the row.

According to an embodiment, each elementary transducer belongs to only a first elementary group only formed of elementary transducers of a same of the array of elementary transducers, and a second elementary group only formed of elementary transducers of a same column of the array of elementary transducers.

According to an embodiment, each elementary transducer belongs to a single elementary group.

According to an embodiment, the probe comprises, for each elementary transducer, a specific receive circuit connected to an electrode of the transducer.

According to an embodiment, each transmit-receive circuit comprises an amplifier and a time gain compensation circuit between said electrode of the transducer and an input terminal of the micro-beamforming circuit.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 schematically and partially shows an example of an ultrasonic imaging probe;

FIG. 2 schematically and partially shows an example of arrangement of elementary transducers of an ultrasonic imaging probe according to an embodiment;

FIG. 3 schematically and partially shows another example of arrangement of elementary transducers of an ultrasonic imaging probe according to an embodiment;

FIG. 4 schematically and partially shows another example of arrangement of elementary transducers of an ultrasonic imaging probe according to an embodiment;

FIG. 5 schematically and partially shows another example of arrangement of elementary transducers of an ultrasonic imaging probe according to an embodiment;

FIG. 6 schematically and partially shows another example of arrangement of elementary transducers of an ultrasonic imaging probe according to an embodiment;

FIG. 7 schematically and partially shows another example of arrangement of elementary transducers of an ultrasonic imaging probe according to an embodiment;

FIG. 8 schematically and partially shows another example of arrangement of elementary transducers of an ultrasonic imaging probe according to an embodiment;

FIG. 9 schematically and partially shows another example of embodiment of an ultrasonic imaging probe according to an embodiment;

FIG. 10 schematically and partially shows another example of embodiment of an ultrasonic imaging probe according to an embodiment;

FIG. 11 Schematically and Partially Shows Another example of arrangement of elementary transducers of an ultrasonic imaging probe according to an embodiment; and

FIG. 12 schematically and partially shows another example of arrangement of elementary transducers of an ultrasonic imaging probe according to an embodiment.

### DESCRIPTION OF EMBODIMENTS

The same elements have been designated by the same references in the various figures. In particular, structural and/or functional elements common to the different embodiments may have the same references and may have identical structural, dimensional and material properties.

For the sake of clarity, only those steps and elements that are useful for understanding the described embodiments have been shown and are described in detail. In particular, the various possible applications of the described ultrasonic imaging probes and systems have not been detailed, the described embodiments being compatible with usual applications of ultrasonic imaging probes. Further, the properties (frequencies, shapes, amplitudes, etc.) of the electrical excitation signals applied to the ultrasonic transducers have not been detailed, the described embodiments being compatible with excitation signals currently used in ultrasonic imaging systems, which can be selected according to the considered application and, in particular, to the nature of the body to be analyzed, for example according to the physiology of the tissues to be analyzed and to the type of information which is desired to be acquired. Similarly, the various processes applied to the electrical signals supplied by the ultrasonic transducers and read by the control circuit to extract useful information about the body to be analyzed have not been detailed, the described embodiments being compatible with the processes commonly used in ultrasonic imaging systems. Further, the forming of the ultrasonic transducers and of the electronic circuits for controlling the transducers has not been described in detail, the detailed forming of these elements being within the abilities of those skilled in the art based on the indications of the present disclosure, using known ultrasonic transducer and electronic circuit manufacturing techniques.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as the terms “front”, “back”, “top”, “bottom”, “left”, “right”, etc., or relative position qualifiers, such as the terms “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%.

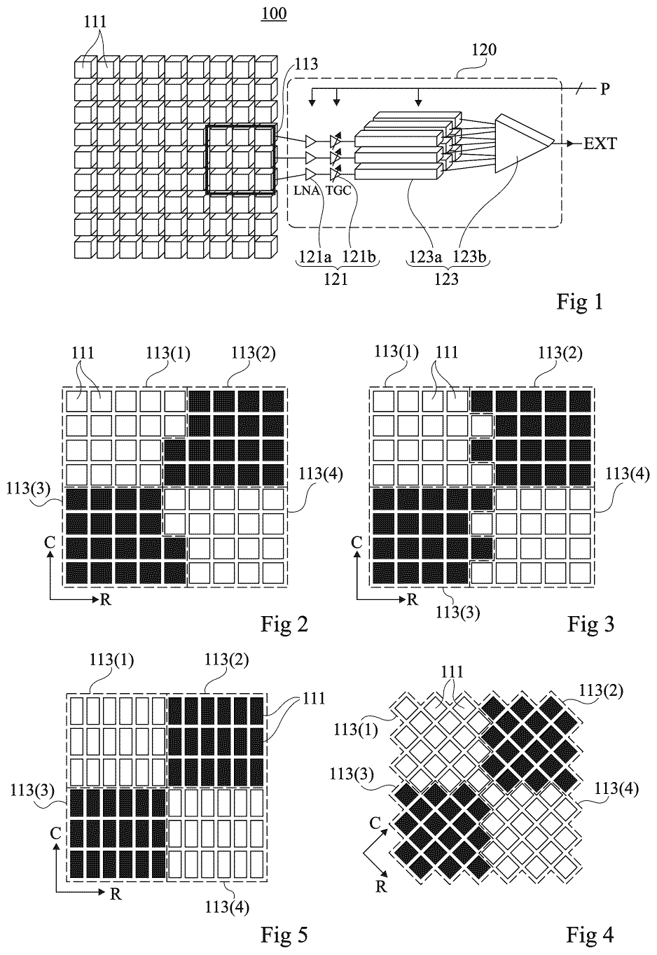

FIG. 1 is an exploded view schematically and partially showing an example of an ultrasonic imaging probe 100.

Probe 100 comprises a plurality of elementary ultrasonic transducers 111 and electronic circuits for controlling the transducers.

In operation, the assembly of the ultrasonic transducers of the probe is arranged opposite a body, an image of which is to be acquired. The electronic control circuits are configured to apply electrical excitation signals to the transducers so as to cause the emission of ultrasonic waves by the transducers toward the body to be analyzed. The ultrasonic waves emitted by the transducers are reflected by the body to be analyzed (by its internal and/or superficial structure) and then return to the transducers, which convert them back into electrical signals. These electrical response signals are read by the electronic control circuits and then transmitted to an external processing device EXT (not detailed in the drawing), for example a computer, via a connecting cable (not shown). These signals can be stored and analyzed by the external device to deduce information about the studied body. It should be noted in FIG. 1 that the transmission circuits, adapted to applying electrical excitation signals to the transducers, are not shown in FIG. 1.

Probe 100 is for example a portable probe intended to be positioned and, possibly displaced, manually on a patient's body.

In the example of FIG. 1, probe 100 comprises a plurality of elementary ultrasonic transducers 111 arranged in an array of rows and columns. Elementary transducers 111 are, for example, all identical, to within manufacturing dispersions. In FIG. 1, a 9*9 array of elementary transducers 111 has been shown. In practice, the array may comprise from several thousand to several tens of thousands of individually-addressable elementary transducers 111.

Each element transducer 111 comprises two electrodes (not detailed in the drawing) enabling to apply an electrical excitation signal to the transducer and to read an electrical response signal of the transducer.

The elementary transducers 111 are, for example, CMUT-type transducers (micro-machined capacitive ultrasonic transducers), such as PMUT-type transducers (piezoelectric micro-machined ultrasonic transducers), piezoelectric crystal or ceramic transducers, or any other type of ultrasonic transducers.

As an example, the pitch between transducers is in the order of from a few tens to a few hundreds of micrometers in the row direction and in the column direction. The described embodiments are however not limited to this specific case. In the example of FIG. 1, the elementary transducers 111 have a square shape, the orthogonal sides of the squares being respectively parallel to the row direction and to the column direction, and the pitch between transducers being identical in the row direction and in the column direction.

In the example of FIG. 1, the elementary transducers 111 of probe 100 are distributed into elementary groups 113, each comprising a square sub-array of n*n adjacent transducers. In the shown example, n is equal to 3. As an example, each elementary transducer 111 belongs to one and only one elementary group 113.

Probe 100 further comprises an analog transmit-receive circuit 120, only partially shown in FIG. 1. Analog transmit-receive circuit 120 comprises, for each elementary transducer 111, an elementary receive circuit 121. Analog transmit-receive circuit 120 may further comprise, for each elementary transducer, an elementary transmit circuit (not shown), and a transmit-receive switch (not shown).

As an example, the elementary transmit circuit is adapted to applying an electrical excitation signal to elementary transducer 111 during a phase of transmission of an ultrasonic wave. The elementary receive circuit 121 is adapted to conditioning and amplifying an electrical response signal generated by transducer 111 during a phase of reception of an ultrasonic wave. The transmit-receive switch enables to connect an electrode of elementary transducer 111 either to an output terminal of the elementary transmit circuit (during the phase of transmission of an ultrasonic wave) or to an input terminal of the elementary receive circuit (during the phase of reception of an ultrasonic wave).

The transmit circuit comprises, for example, a pulse generator having an input terminal intended to receive a logic control signal, and an output terminal coupled, for example connected, to the output terminal of the transmit circuit. The input terminal of the pulse generator may be coupled, for example connected, to an output node of a logic circuit (not shown) for controlling the probe. When the logic signal applied to the input terminal of the pulse generator is in a first state, the pulse generator delivers on its output terminal a high-level voltage, and when the logic signal applied to the input terminal of the pulse generator is in a second state, the pulse generator delivers on its output terminal a low-level voltage. The output signal of the pulse generator corresponds to a signal for exciting transducer 111, which can be applied directly to the transducer electrode.

In this example, receive circuit 121 comprises a receive amplifier 121a, preferably a low-noise amplifier (LNA), having an input terminal coupled, for example connected, to the input terminal of the receive circuit. Amplifier 121a is, for example, a linear amplifier. Further, in this example, receive circuit 121 comprises a time gain compensation (TGC) circuit 121b having an input terminal coupled, for example connect, to an output terminal of receive amplifier 121a, and an output terminal coupled, for example connected, to an output terminal of receive circuit 121. Circuit 121b is configured to apply a variable analog gain as a function of time to the response signal of the transducer, during a receive phase. More particularly, during a phase of reception of an ultrasonic wave returned by transducer 111, the gain applied by circuit 121b to the response signal of the transducer progressively increases as a function of time, and thus as a function of the depth of the explored area, so as to compensate for the attenuation of the ultrasonic signal by the explored medium. As a variant, not shown, time gain compensation circuit 121b may be placed upstream of amplifier 121a, between the input terminal of receive circuit 121 and the input terminal of amplifier 121a. In this case, circuit 121b applies a progressive attenuation so as to homogenize the amplitude of the signal as a function of the exploration depth before amplification by circuit 121a. In another variant, the gain compensation function is implemented by amplification circuit 121a itself (non-linear amplification).

Analog transmit-receive circuit 120 further comprises, for each elementary group 113 of ultrasonic transducers 111, an analog micro-beamforming circuit 123 individually coupled to each transducer in the group and adapted to delivering an analog signal corresponding to a sum of analog response signals of the elementary transducers 111 in the group.

More particularly, in this example, each micro-beamforming circuit 123 comprises, for each elementary transducer 111 of group 113, a delay circuit 123a, that is, n*n delay circuits 123a per circuit 123. Each delay circuit 123a has an input terminal coupled, for example connected, to the output terminal of the receive circuit 121 of the associated elementary transducer 111, and an output terminal. Each circuit 123a is adapted to delivering on its output terminal an analog signal corresponding to the analog signal applied to its input terminal delayed by a predetermined, fixed, or adjustable delay. The delays introduced by circuits 123a may be identical for all the elementary transducers 111 of elementary group 113, or individually differentiated for each transducer.

Each micro-beamforming circuit 123 further comprises an analog summing circuit 123b comprising a specific input terminal per elementary transducer 111 of the associated elementary group 113, that is, non individualized input terminals in this example, and a single output terminal. The input terminals of analog summing circuit 123b are coupled, for example connected, respectively and individually to the output terminals of the n*n elementary receive circuits 121 associated with the n*n elementary transducers 111 of elementary group 113. Circuit 123b is adapted to delivering, at its output terminal, an analog signal representative of the sum or superimposition of the analog signals applied to its n*n input terminals.

The output signal of each micro-beamforming circuit 123 may be transmitted to the external control and processing device (EXT) in analog form via a single conductive wire. As a variant, the probe may comprise a specific analog-to-digital converter (not shown) at the output of each summing circuit 123b, the output signals of the micro-beamforming circuits 123 then being transmitted outside the probe in digital form.

As illustrated in FIG. 1, the electronic transmit-receive circuit 120 comprises one or more input terminals adapted to receiving power and control signals P. The power and control signals P are, for example, transmitted from the external device via one or more conductive wires of the connection cable electrically coupling probe 100 to the external device.

The provision of the analog micro-beamforming circuits 123 in probe 100 advantageously enables to limit (divide by n*n) in the example of FIG. 1, the number of response signals to be transmitted to the output of analog transmit-receive circuit 120 during a phase of reception of an ultrasonic wave. All the response signals generated by micro-beamforming circuits 123 can be transmitted outside the probe (before or after digitization), for example to implement ultra-fast imaging methods.

Ultrafast ultrasound imaging differs from so-called conventional ultrasonic imaging.

Conventional imaging is based on the focusing of ultrasonic waves by the application of delay laws to the elementary ultrasonic transducers on transmission. The same process is applied on reception to reconstruct the acoustic image received by the network of ultrasonic transducers. In other words, delay and summing processing operations are applied to obtain the desired focusing on transmission and on reception.

Ultrafast imaging consists of insonifying (acoustically exciting) the entire medium by means of multiple unfocused acoustic waves (for example, planar or divergent waves). The system records the electrical response signals generated by all the elementary transducers during an acquisition time window, then, based on these signals, reconstructs the resulting image for a large number of focal points, until sufficient information about the studied body is obtained.

Ultrafast ultrasound imaging enables to observe very fast phenomena (typically 1,000 images/second) at the cost of numerous calculations. It is complementary to conventional imaging, which enables to obtain an equivalent image quality with much less computation but also a slower image rate (typically 50 images/sec).

Micro-beamforming enables to decrease the number of response signals to be processed and is based on conventional delay and summing imaging algorithms applied at the scale of the elementary groups 113 of transducers, also known as sub-apertures. The electrical signals generated by the elementary transducers 111 of each elementary group or sub-aperture 113 are delayed and summed by the elementary analog micro-beamforming circuit 123 of the group, embedded in the probe. This summing enables to have a single output data transmission conductor between each elementary group 113 and the imaging system. The system can then reconstruct the image seen by the probe by applying a new delay and summing processing to the signals generated by the micro-beamforming circuits 123, that is, on macro-elements, each corresponding to an elementary group 113. In other words, conversely to a so-called fully populated probe (that is, in which the set of individual response signals of the elementary transducers is transmitted to the system), in a micro-beamforming probe of the type described in relation with FIG. 1, the delay and summing processing operations are performed in two steps, a first step in the probe and a second step outside the probe.

In the example of FIG. 1, the elementary transducers 111 have a square shape, and the sub-apertures or elementary groups 113 also have a square shape.

The inventors have identified that, according to the type of images which is desired to be acquired, it may be advantageous to provide micro-beamforming circuits coupled to elementary groups of ultrasonic transducers having different geometries.

Cases where a two-dimensional image of the body to be analyzed is desired to be acquired (2D imaging) can in particular be distinguished from cases where a three-dimensional image of the body under study is desired to be acquired (3D imaging).

In 3D imaging, it is preferable for the distribution of the elementary groups to be as isotropic as possible, that is, for the pitch between elementary groups 113 to be the Same or substantially the same in the row direction and in the column direction of the array of elementary transducers 111.

In this respect, the choice of a square sub-array of n*n elementary transducers as described in relation with FIG. 1 is an advantageous solution.

However, in certain cases, the miniaturization capabilities of the electronics embedded in the probe may enable to form micro-beamforming circuits 123 capable of addressing a number of reception channels different from a square number. In this case, in order to use all the channels of each micro-beamforming circuit, it may be advantageous to define elementary groups 113 of non-square shape or elementary transducers 111 of non-square shape.

Thus, according to an aspect of an embodiment, there is provided an ultrasonic probe embedding electronic micro-beamforming circuits of the type described in relation with FIG. 1, differing from the probe of FIG. 1 by the geometric construction of the elementary groups 113 of ultrasonic transducers 111.

Non-limiting examples of patterns of the elementary groups 113 of such a probe are illustrated in FIGS. 2, 3, 4, and 5.

In FIGS. 2, 3, 4, and 5, the direction of the rows of elementary transducer array 111 has been represented by an axis R and the direction of the columns of elementary transducer array 111 has been represented by an axis C.

In each of FIGS. 2, 3, 4, and 5, only one set of 2*2 elementary groups 113, respectively designated with reference 113(1), 113(2), 113(3), and 113(4), has been shown. In practice, the shown pattern can be repeated identically across the entire array of elementary transducers 111.

In the examples of FIGS. 2, 3, 4, and 5, the number of adjacent elementary transducers 111 per elementary group 113 is equal to 18. The described embodiments are of course not limited to this specific case.

Elementary groups 113 have, for example, interlocking shapes in the row direction and/or in the column direction, for example, as illustrated in relation with FIGS. 2, 3, and 4.

By interlocking shapes in the row direction, there is meant that at least one subset of first and second adjacent elementary groups 113 in the row direction comprises at least one column comprising elementary transducers 111 belonging to the first elementary group and transducers 111 belonging to the second elementary group.

By interlocking shapes in the column direction, there is meant that at least one subset of first and second adjacent elementary groups 113 in the column direction comprises at least one row comprising elementary transducers 111 belonging to the first elementary group and transducers 111 belonging to the second elementary group.

Two adjacent elementary groups 113 for example have symmetrical shapes with respect to an axis parallel to the row direction or parallel to the column direction.

For example, each elementary group 113 of ultrasonic transducers has at least one dimension in the row direction which is different from a dimension in the column direction.

FIG. 2 illustrates a first example of embodiment in which elementary groups 113 have head-to-tail L-shapes, interlocked in the row direction.

FIG. 3 illustrates a second example of embodiment in which elementary groups 113 have head-to-tail F shapes, interlocked in the row direction.

FIG. 4 illustrates a third example of embodiment in which elementary groups 113 have interlocking cross shapes, the main arms of which are respectively parallel to the row direction and to the column direction.

As a variant, elementary groups 113 have a square shape, and elementary transducers 111 each have an elongated shape in the row or column direction, for example a rectangular shape.

FIG. 5 illustrates an example of embodiment in which elementary transducers 111 each have a generally rectangular shape, the longest side of the rectangle (length) being parallel to the column direction and the shortest side (width) of the rectangle being parallel to the row direction. In this example, each elementary group 113 comprises a sub-array of n*m elementary transducers 111, n being the number of rows in the sub-array and m being the number of columns in the sub-matrix, n and m being selected so that elementary group 113 has a substantially square shape.

More specifically, in the example of FIG. 5, each elementary transducer has a length approximately equal to twice its width, and m is equal to twice n (n=3 and m=6 in the shown example), so that elementary group 113 has a substantially square general shape.

Ultrafast 2D imaging may consist of a reconstruction of a single plane after having insonified the entire medium. The image can be optimized by using, on transmission, a delay law enabling to concentrate the energy in the plane to be imaged. A delay law divergent or flat for the plane to be imaged and focused perpendicularly to this plane, is for example used for this purpose, for example a saddle-shaped delay law. In receive mode, only the plane to be imaged is reconstructed. The return wave is focused perpendicularly to the plane to be imaged. An example of such an imaging mode is described in the document entitled “3D ultrafast echocardiography: toward a quantitative imaging of 41 the myocardium”—Victor Finel—-UniversitéSorbonne Paris Cité, 2018, in particular in section 2.3.1.1 of this document.

In this case, it is advantageous for the pitch between elementary groups to be as close as possible to that of a linear probe in the direction of the plane to be imaged.

Thus, according to an aspect of an embodiment, each elementary group 113 is formed of adjacent elementary transducers 111 of one and the same row or column of the array of elementary transducers.

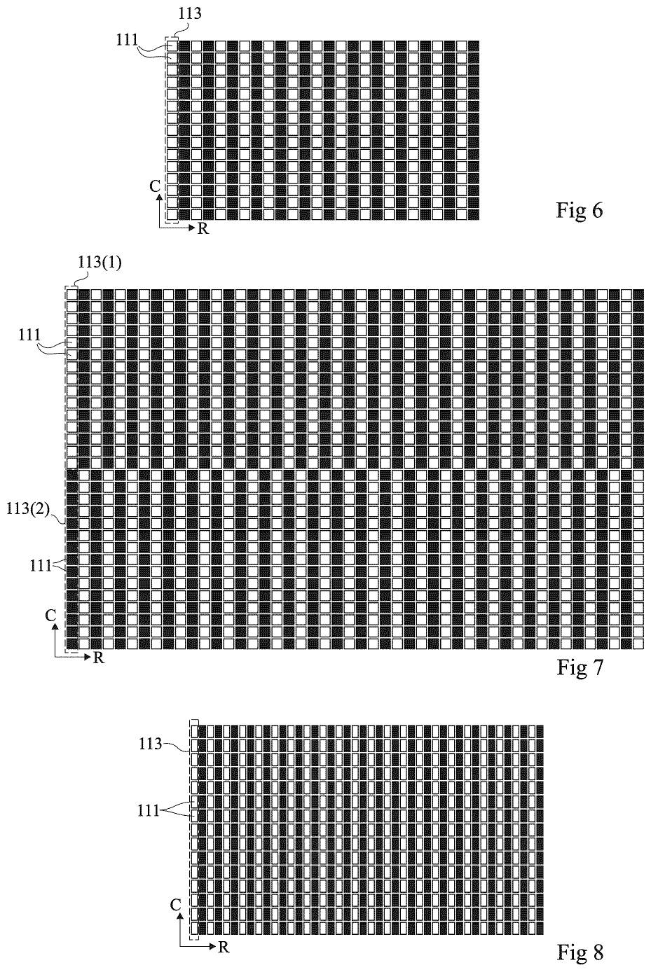

FIGS. 6, 7, and 8 schematically illustrate examples of 2D ultrasonic imaging probes according to this embodiment. In these examples, the probe is particularly adapted to imaging one or more planes parallel to the row direction of the array.

In the examples in FIGS. 6 and 7, the elementary transducers 111 each have a square shape.

In the example of FIG. 6, each column of the array of elementary transducers 111 defines an elementary group 113. In other words, each elementary group 113 is formed of all the elementary transducers 111 of a same column of the array.

In the example of FIG. 7, each column of the array of elementary transducers 111 comprises a plurality of elementary groups 113, two elementary groups 113 respectively designated with references 113(1) and 113(2) in the shown example. Each elementary group 113 is formed by an assembly of adjacent elementary transducers 111 of a same column of the array.

The example of FIG. 8 is similar to the example of FIG. 6, with the difference that, in the example in FIG. 8, the elementary transducers 111 each have an elongated direction in the column direction, for example a rectangular shape, for example of the type described in relation with FIG. 5.

The embodiment of FIG. 8 may, of course, be combined with the embodiment of FIG. 7.

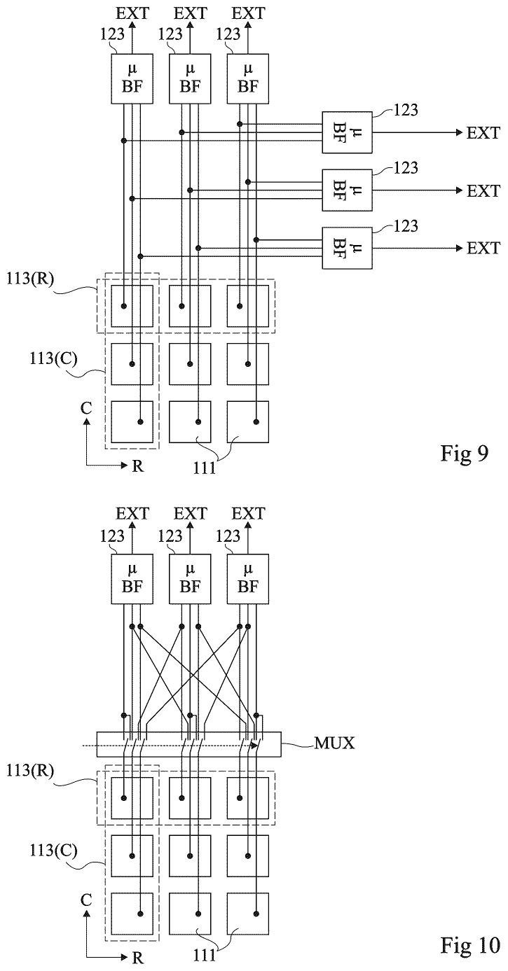

FIG. 9 schematically and partially shows another example of embodiment of an ultrasonic imaging probe according to an embodiment.

In this example, the probe is adapted to image one or more planes parallel to the row direction of the array, and one or more planes parallel to the column direction of the array.

There have been schematically shown in this example elementary groups 113 of 3 elementary transducers 111 each. The described embodiments are of course not limited to this specific case.

In the example of FIG. 9, each elementary transducer belongs to two and only two elementary groups 113(C) and 113(R). The first elementary group 113(C) is formed of an assembly of adjacent elementary transducers of a same column of the array of elementary transducers 111, and the second elementary group 113 (R) is formed of an assembly of adjacent elementary transducers of a same row of the array.

As an example, each first elementary group 113(1) is formed of all the elementary transducers 111 of the corresponding column, as described in relation with FIG. 6. As a variant, each first elementary group 113(1) is formed of a sub-assembly of adjacent elementary transducers 111 of the corresponding column, as described in relation with FIG. 7. Similarly, each second elementary group 113(2) may be formed of all the elementary transducers 111 of the corresponding row, or of a sub-assembly of adjacent elementary transducers 111 of the corresponding row.

In FIG. 9, there has further been schematically shown, for each elementary group 113, a dedicated micro-beamforming circuit 123 (μBF) connected to the elementary transducers in the group. For the sake of simplicity, the receive circuits 121 (FIG. 1) connected to the elementary transducers 111 have not been shown in detail in FIG. 9.

Thus, in the example of FIG. 9, each elementary transducer 111 is coupled to two and only two micro-beamforming circuits 123.

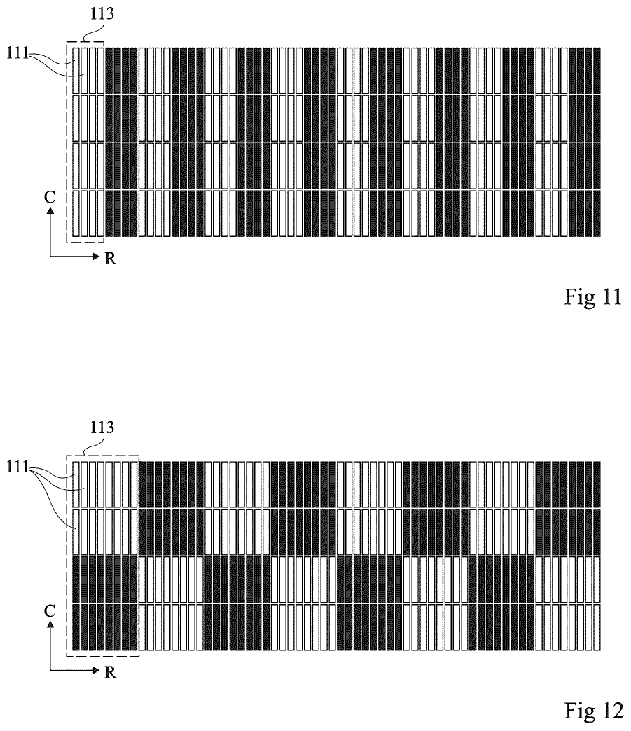

FIG. 10 schematically and partially shows another example of an ultrasonic imaging probe according to an embodiment.

The example in FIG. 10 differs from the example of FIG. 9 mainly in that, in the example in FIG. 10, the same micro-beamforming circuits 123 are pooled and shared by the elementary groups 113(R) and by the elementary groups 113(C).

More specifically, in this example, each micro-beamforming circuit 123 is shared by one and only one elementary group 113(R) and one and only one elementary group 113(C).

For this purpose, a multiplexing circuit MUX enables to couple to the input terminals of circuit 123 either the elementary transducers 111 of the associated elementary group 113(R), or the elementary transducers 111 of the associated elementary group 113(C).

Thus, the number of micro-beamforming circuits is divided by two with respect to the example of FIG. 9.

FIGS. 11 and 12 show other examples of arrangements of the elementary transducers of an ultrasonic imaging probe according to an embodiment.

The examples of FIGS. 11 and 12 concern two dimensional (2D) imaging probes. The probes of FIGS. 11 and 12 are more particularly probes said to be of 1.75 D type, that is, array probes having an elevational pitch between transducers, that is, in the column direction, equal to several times the central wavelength λ of the emitted ultrasonic waves, while the azimuthal pitch between transducers, that is in the row direction, is in the range from λ to λ/2.

The transition from a 1 D probe (linear array of elementary transducers) to a 1.75 D probe enables in particular to improve its imaging capabilities in terms of:
variation in aperture size and elevational acoustic apodization;
dynamic focusing in transmit and receive mode;
beam deflection outside the imaging plane to better discretize reflectors.

In the examples of FIGS. 11 and 12, the probe comprises four elementary transducers per column and 64 columns. The described embodiments are however not limited to this specific case.

In the examples of FIGS. 11 and 12, the number of adjacent elementary transducers 111 per elementary group group 113 is equal to 16. Here again, the described embodiments are not limited to this specific case.

In the example of FIG. 11, each elementary group 113 is formed by all the elementary transducers 111 of four adjacent columns of elementary transducers. Thus, in this example, the elementary transducers of a same column are coupled to one and the same micro-beamforming circuit 123.

In the example of FIG. 12, each elementary group 113 is formed of all the elementary transducers of a sub-array of two adjacent rows by 8 adjacent columns of elementary transducers. Thus, in this example, each column comprises two adjacent transducers coupled to a first micro-beamforming circuit 123 and two adjacent transducers coupled to a second micro-beamforming circuit 123.

Various embodiments and variants have been described. Those skilled in the art will understand that certain features of these various embodiments and variants may be combined, and other variants will occur to those skilled in the art. In particular, the described embodiments are not limited to the specific examples of arrangements of elementary groups 113 described in relation with FIGS. 2, 3, 4, 5, 6, 7, 8, 9, and 10.

Finally, the practical implementation of the described embodiments and variants is within the abilities of those skilled in the art based on the functional indications given hereabove.

1. Ultrasonic imaging probe (100) comprising a plurality of elementary ultrasonic transducers (111) arranged in an array of rows and columns, the probe comprising, for each elementary ultrasonic transducer (111), a specific receive circuit (121) connected to an electrode of the transducer and adapted to amplifying an electrical response signal generated by the elementary transducer (111) during a phase of reception of an ultrasonic wave, wherein the elementary transducers (111) are distributed into a plurality of elementary groups (113), each comprising a plurality of transducers (111), the probe comprising, for each elementary group (113), an analog micro-beamforming circuit (123) individually coupled to an output terminal of the receive circuit (121) of each transducer (111) in the group (113), and adapted to delivering an analog signal generated by delay and summing of analog output signals of the receive circuits (121) of the elementary transducers (111) in the group (113),
wherein each elementary group (113) is formed of an assembly of adjacent elementary transducers (111), said assembly having at least one dimension, in the row direction, different from a dimension, in the column direction,
or wherein the elementary transducers (111) each have an elongated shape in the row or column direction, and each elementary group (113) is formed of an assembly of adjacent elementary transducers (111), said assembly having a square general shape.

2. Probe (100) according to claim 1, wherein each elementary group (113) comprises a number of elementary transducers (111) different from a squared integer number.

3. Probe (100) according to claim 1 or 2, wherein the elementary groups (113) have interlocking shapes.

4. Probe (100) according to claim 3, wherein the elementary groups (113) have interlocking head-to-tail L shapes, or interlocking head-to-tail F-shapes.

5. Probe (100) according to claim 3, wherein the elementary groups (113) have interlocking cross shapes.

6. Probe (100) according to claim 1 or 2, wherein each elementary group (113) is only formed of adjacent elementary transducers (111) of a same row or of a same column of the array of elementary transducers.

7. Probe according to claim 6, wherein each column of elementary transducers (111) of the array of elementary transducers comprises a plurality of elementary groups (113), each comprising a plurality of adjacent elementary transducers (111) of the column, and/or each row of elementary transducers (111) of the array of elementary transducer comprises a plurality of elementary groups (113), each comprising a plurality of adjacent elementary transducers (111) of the row.

8. Probe (100) according to claim 6 or 7, wherein each elementary transducer (111) belongs to only a first elementary group (113 (R) ) only formed of elementary transducers (111) of a same row of the array of elementary transducers, and a second elementary group (113 (C) ) only formed of elementary transducers (111) of a same column of the array of elementary transducers.

9. Probe (100) according to any of claims 1 to 7, wherein each elementary transducer (111) belongs to a single elementary group (113).

10. Probe (100) according to any of claims 1 to 9, wherein each transmit-receive circuit comprises an amplifier (121a) and a time gain compensation circuit (121b) between said transducer electrode and an input terminal of the micro-beamforming circuit (123).
